(19) United States
(12) Patent Application Publication
(10) Pub. No.: US 2021/0274141 A1
(43) Pub. Date: Sep. 2, 2021

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Masahiro Takayama, Tokyo (JP)

(21) Appl. No.: 17/170,069

(22) Filed: Feb. 8, 2021

(30) Foreign Application Priority Data
Feb. 28, 2020 (JP) 2020-033749

(51) Int. Cl. H04N 9/73; G06N 20/00; H04N 9/64; H04N 9/75

(52) U.S. Cl. CPC H04N 9/735; H04N 9/75; H04N 9/646; G06N 20/00

(57) ABSTRACT

An image processing apparatus includes an acquisition unit for acquiring image data, a determination unit for determining a specific area from the acquired image data, a first calculation unit for calculating a first white balance correction value in accordance with white pixels of an area including an area other than the specific area, a second calculation unit for calculating a second white balance correction value based on a color evaluation value of the specific area, a third calculation unit for calculating a third white balance correction value by performing weighted addition of the first white balance correction value and the second white balance correction value based on a distribution of the color evaluation value of the specific area.

### BACKGROUND OF THE INVENTION

### Field of the Invention

The present invention relates to a white balance adjustment technique in an image processing apparatus.

### Description of the Related Art

In recent years, a so-called TTL (Through The Lens) method has been widely used in an automatic white balance processing performed in an image capturing device or the like. In the automatic white balance processing by the TTL method, the color of the light source is estimated according to the image obtained as a result of the image capturing. Then, in order to accurately calculate the white balance (hereinafter WB) correction value, it is necessary to distinguish the light source color and the subject color in the image.

In addition, an image processing apparatus which uses a neural network to determine the similarity between each preset reference scene and a shooting scene, and specify color space coordinates corresponding to the shooting scene is known (see Japanese Patent Laid-Open No. 2013-168723).

However, in the image processing apparatus described in the above-mentioned Japanese Patent Laid-Open No. 2013-168723, there is a possibility that an inappropriate white balance correction value is calculated when the determination is erroneous.

### SUMMARY OF THE INVENTION

The present invention has been made in consideration with the above-mentioned problems, and makes it possible to perform white balance adjustment with high accuracy.

According to a first aspect of the present invention, there is provided an image processing apparatus comprising: at least one processor or circuit configured to function as: an acquisition unit configured to acquire image data; a determination unit configured to determine a specific area from the acquired image data; a first calculation unit configured to calculate a first white balance correction value in accordance with white pixels of an area including an area other than the specific area; a second calculation unit configured to calculate a second white balance correction value based on a color evaluation value of the specific area; and a third calculation unit configured to calculate a third white balance correction value by performing weighted addition of the first white balance correction value and the second white balance correction value based on a distribution of the color evaluation value of the specific area.

According to a second aspect of the present invention, there is provided an image processing method comprising: acquiring an image data; determining a specific area from the acquired image data, performing a first calculation for calculating a first white balance correction value in accordance with white pixels of an area including an area other than the specific area, performing a second calculation for calculating a second white balance correction value based on a color evaluation value of the specific area, performing a third calculation for calculating a third white balance correction value by performing weighted addition of the first white balance correction value and the second white balance correction value based on a distribution of the color evaluation value of the specific area.

Further features of the present invention will become apparent from the following description of exemplary embodiments with reference to the attached drawings.

### BRIEF DESCRIPTION OF THE DRAWINGS

FIG. 1 is a block diagram illustrating a configuration example of a digital camera which is an embodiment of an image processing apparatus of the present invention.

FIG. 2 is a block diagram showing an example of the functional configuration of the image processing unit.

FIGS. 3A and 3B are diagrams showing an example of area division of the detection unit.

FIG. 4 is a flowchart showing the calculation process of the WB correction value in the WB control unit.

FIG. 5 is a flowchart showing a calculation process of the first WB correction value in the WB control unit.

FIGS. 6A to 6C are diagrams showing the detection range of the white detection range and detection range of a specific area.

FIG. 7 is a flowchart showing a calculation process of the second WB correction value in the WB control unit.

FIG. 8 is a diagram showing a color evaluation value distribution of the green area.

FIGS. 9A and 9B are distribution diagram of color evaluation values showing difficult cases of color temperature estimation by the specific area.

FIGS. 10A to 10D are diagrams illustrating an example of calculating the mixing ratio of the WB correction values.

### DESCRIPTION OF THE EMBODIMENTS

Hereinafter, embodiments will be described in detail with reference to the accompanying drawings. The following embodiments do not limit the claimed invention. Although a plurality of features are described in the embodiments, not all of the plurality of features are essential to the present invention, and the plurality of features may be arbitrarily combined. Furthermore, in the accompanying drawings, the same reference numerals are assigned to the same or similar components, and a repetitive description thereof is omitted.

### First Embodiment

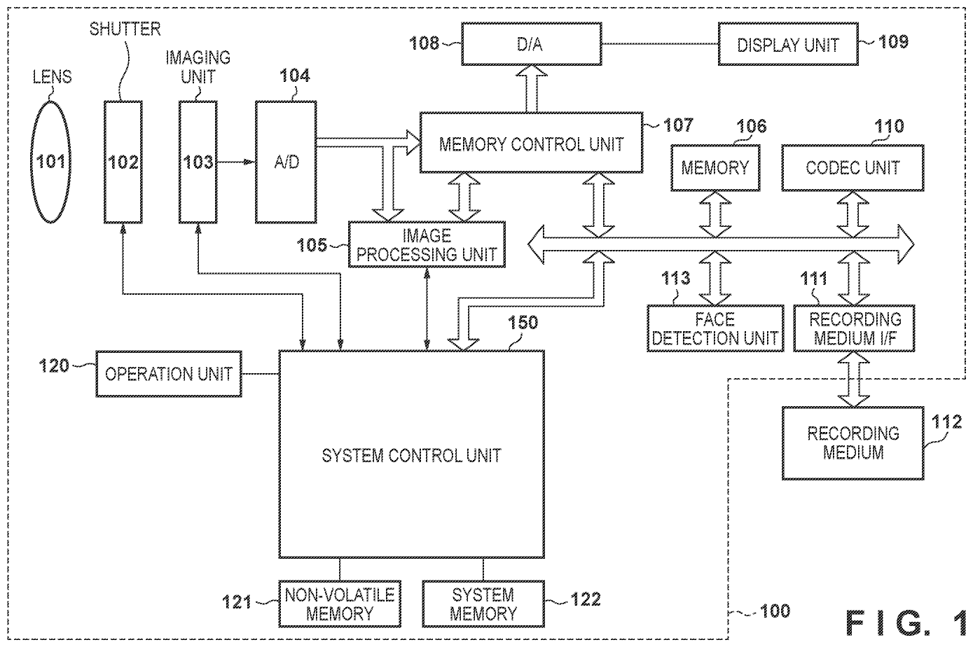

FIG. 1 is a block diagram showing a configuration example of a digital camera 100 which is an embodiment of the image processing apparatus of the present invention.

In FIG. 1, a lens group 101 is a zoom lens including a focus lens. A shutter 102 is provided with an aperture function and exposes the image sensor included in the imaging unit 103 in accordance with the control of the system control unit 150. The imaging unit 103 includes an image sensor such as a CCD/CMOS image sensor, and converts the optical image obtained through the lens group 101 into an electric signal by photoelectric conversion. An A/D converter 104 converts the analog signal read from the imaging unit 103 into a digital signal and outputs the image data to the image processing unit 105.

The image processing unit 105 performs various image processing such as white balance adjustment and y correction on the image data output from the A/D conversion unit 104 or the image data output from the memory control unit 107. Further, the image processing unit 105 performs predetermined evaluation value calculation processing using the face detection result of the face detection unit 113 and the captured image data, and the system control unit 150 performs exposure control and focus adjustment control based on the obtained evaluation value. In this way, AF (automatic focus) processing, AE (automatic exposure) processing, AWB (automatic white balance) processing, etc. by the TTL (through the lens) method are carried out.

The memory 106 temporarily stores image data when the image processing unit 105 performs various image processing, and stores image data read from the recording medium 112 through the recording medium interface (I/F) 111 and image data for display on the display unit 109. The memory control unit 107 controls reading and writing of the memory 106. The D/A converter 108 converts the input digital signal into an analog signal. For example, the image display data stored in the memory 106 is converted into an analog signal and the analog signal is output to the display unit 109.

The display unit 109 includes a display device such as an LCD, and displays a captured image, an image read out from the recording medium 112, a live view image, and the like, as well as a user interface for performing an operation. The codec unit 110 compresses and encodes or decodes the image data. The codec unit 110 encodes or decodes the image data stored in the memory 106 in a format conforming to a standard such as a MPEG.

The recording medium I/F 111 mechanically and electrically connects a removable recording medium 112 such as a semiconductor memory card or a card-type hard disk to the digital camera 100. The face detection unit 113 analyzes the image data to detect an area in which a face appears in the image.

The system control unit 150 includes a CPU or an MPU, executes a program stored in the nonvolatile memory 121 by expanding the program in a work area of the system memory 122, and controls each function of the entire digital camera 100.

The operation unit 120 includes a touch panel for displaying the interface described above, buttons, and switches, and notifies an operation by the user to the system control unit 150.

The non-volatile memory 121 includes, as an auxiliary storage device, a non-volatile solid state memory such as a EEPROM for storing programs, parameters, and the like. The system memory 122 expands a program or the like read from the nonvolatile memory 121 and stores constants and variables for the operation of the system control unit 150, as a main storage device.

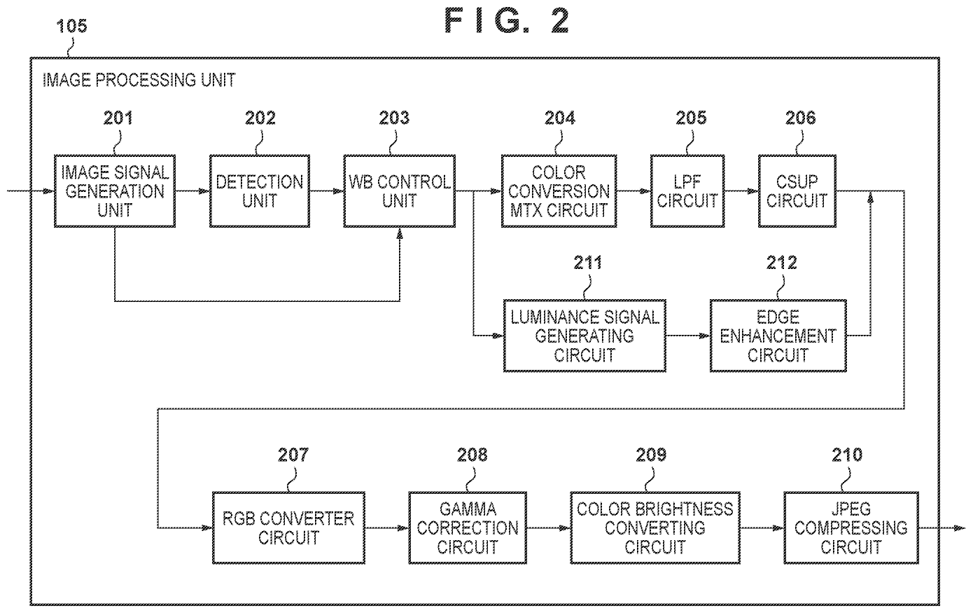

Next, the configuration of the image processing unit 105 and the processing of each unit will be described with reference to FIG. 2.

In FIG. 2, the image data output from the A/D converter 104 is input to the image signal generation unit 201. The image signal generation unit 201 performs simultaneous processing on the input RGB image data composed of the bayer array to generate image signals R, G, and B having a plurality of colors per pixel. The image signal generation unit 201 outputs the generated image signal to the detection unit 202 and the WB control unit 203.

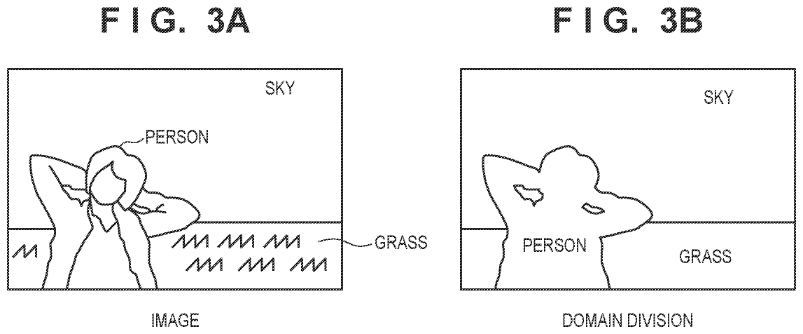

The detection unit 202 detects a specific area such as a green area of grass, leaves, turf, or the like, a skin color area of a person, or the like from the image signal output from the image signal generation unit 201. As a technique for detecting a target area from images, there is a semantic domain division method (Semantic Segmentation) using machine-learning. The semantic domain division method is an image recognition method in which a category of an area occupied by a recognition target in an image is recognized from a feature amount or the like of the area. FIGS. 3A and 3B show an example of input and output in the semantic domain division method. A user defines area category to be recognized, such as Person, Sky, Grass, and the like, with respect to FIG. 3A, and the area category is output on a pixel-by-pixel basis as shown in FIG. 3B. In the present embodiment, the area category is output on a pixel-by-pixel basis, and the reliability indicating the likelihood of the category is output on a pixel-by-pixel basis or a specific block-by-block basis. For example, in the case of FIG. 3B, higher reliability is output for pixels or blocks included in the area of “Grass” for the category “grass”. The reliability can be expressed, for example, in percentage units of 0 to 100. Generally, as a method for achieving this recognition and division, a method based on supervised learning, in which data that is ideally divided into regions and is tagged with categories for each region is used as a correct image, etc. is used.

The WB control unit 203 calculates the WB correction value based on the image signal output by the image signal generation unit 201 and the specific area information output (determined) by the area detection circuit in the detection unit 202. Then, the WB control unit 203 corrects the white balance of the image data using the calculated WB correction value. The detailed configuration of the WB control unit 203 and the method of calculating the WB correction value will be described later.

The color conversion matrix (MTX) circuit 204 multiplies the color gain so that the image data corrected by the WB control unit 203 is reproduced in the optimum color, and converts the image data into two color difference signal data R-Y and B-Y. The low-pass filter (LPF) circuit 205 limits the band of the color difference signal data R-Y, B-Y. The CSUP(Chroma Suppress) circuit 206 suppresses the false color signal of the saturated portion of the color difference signal data that is band-limited by the LPF circuit 205.

On the other hand, the image data corrected by the WB control unit 203 is also supplied to the luminance signal (Y) generating circuit 211, and the luminance signal data Y is generated by the luminance signal generating circuit 211. The edge enhancement circuit 212 applies edge enhancement processing to the generated luminance signal data Y.

The color difference signal data R-Y and B-Y output from CSUP circuit 206 and the luminance signal data Y output from the edge enhancement circuit 212 are converted into RGB signal data in the RGB converter circuit 207.

The gamma (γ) correction circuit 208 applies a gradation correction to RGB signal data in accordance with a predetermined γ characteristic. The gamma-corrected RGB signal data, after being converted into YUV signal data by the color brightness converting circuit 209, is compressed and encoded in JPEG compressing circuit 210 and recorded as an image data file on the recording medium 112.

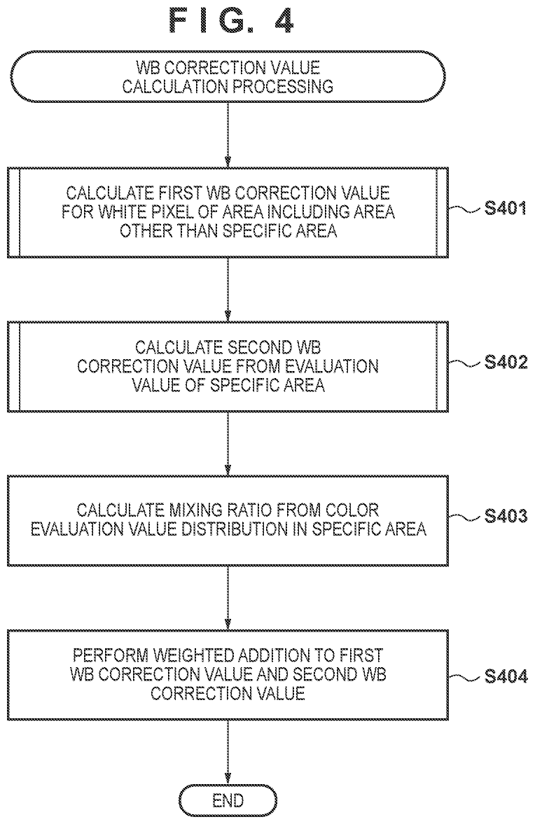

Next, the calculation process of the WB correction value performed in the WB control unit 203 will be described with reference to a flowchart of FIG. 4.

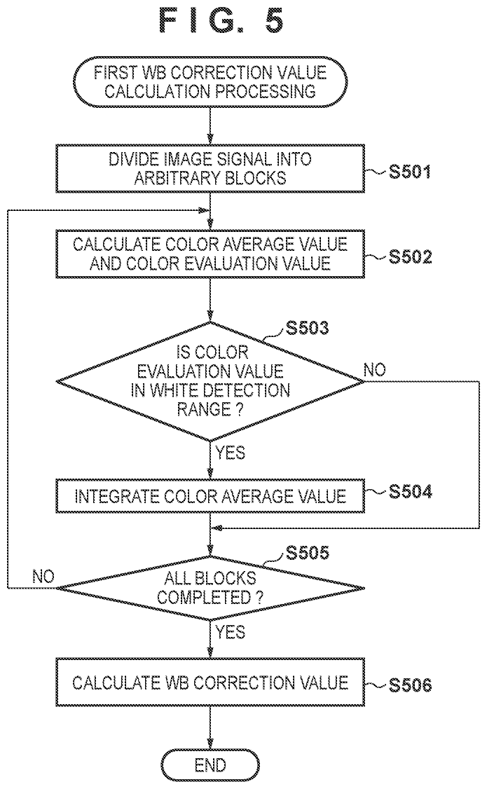

In step S401, the WB control unit 203 calculates the first WB correction value for the white pixel of the area including the area other than the specific area. The calculation of the first WB correction value will be described with reference to the flowchart of FIG. 5.

In step S501, the WB control unit 203 reads out the image signal stored in the memory 106, and divides the image signal into arbitrary m blocks.

In step S502, the WB control unit 203 calculates a color average value (R[i], G[i] B[i]) by averaging pixel values for each color for each block i (integers of i=1 to m), and calculates a color evaluation value (Cx[i], Cy[i]) using the following equation.

Cx[i]=(R[i]−B[i])/Y[i]×1024

Cy[i]=(R[i]+B[i]−2G[i])/Y[i]×1024

Where Y[i]=(R[i]+2G[i]+B[i])/4

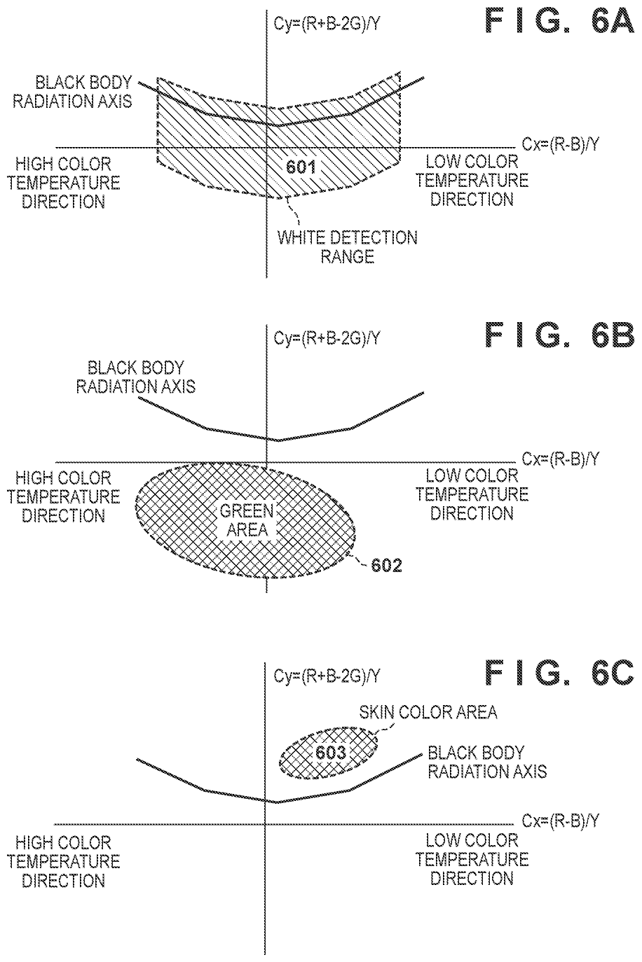

In step S503, the WB control unit 203 performs white detection using a graph having a coordinate axes as shown in FIG. 6A. The negative direction of x coordinate (Cx) represents the color evaluation value when the white of the high color temperature subject is photographed, and the positive direction represents the color evaluation value when the white of the low color temperature subject is photographed. The y-coordinate (Cy) indicates the degree of green component of the light source and Green component increases as the negative direction, i.e. it indicates that the fluorescent lamp. More specifically, in step S503, the WB control unit 203 determines whether or not the color evaluation value (Cx[i], Cy[i]) of the i-th block calculated in step S502 is included in the white detection range 601 set in advance as shown in FIGS. 6A-6C.

The white detection range 601 is obtained by photographing white under different light sources in advance and plotting the calculated color evaluation value. The white detection range can be set separately depending on the shooting mode. In step S503, when it is determined that the calculated color evaluation value (Cx [i], Cy [i]) is included in the white detection range, the WB control unit 203 advances the process to step S504. On the other hand, if it is determined that this is not the case, the process proceeds to step S505.

In step S504, the WB control unit 203 determines that the block corresponding to the color evaluation value is white, and integrates the color average value (R[i], G[i], B[i]) of the block. The processes of these step S503 and step S504 can be represented by the following equations.

$$SumR = {\sum }_{i = 0}^{m} S w [ i ] \times R [ i ]$$

$$SumG = {{\sum }^{m}}_{i = 0} S w [ i ] \times G [ i ]$$

$$SumB = {\sum }_{i = 0}^{m} S w [ i ] \times B [ i ]$$

Here, when the color evaluation value (Cx[i], Cy[i]) is included in the white detection range, Sw[i] is set to 1, and when it is not included in the white detection range, Sw[i] is set to 0, thereby the process of whether adding or not adding the color evaluation value ((R[i], G[i], B[i]) according to the determination of step S503 is substantially performed.

In step S505, the WB control unit 203 determines whether or not the above-described process has been performed on all the blocks. When it is determined that the process has been performed on all the blocks, the WB control unit 203 advances the process to step S506, and if it is determined that not, returns the process to step S502, and repeats the process for the unprocessed block.

In step S506, the WB control unit 203 calculates the first white balance correction value WBCo1 (WBCo1_R,WBCo1_G,WBCo1_B) from the integrated value (SumR, SumG, SumB) of the obtained color evaluation values using the following equation.

WBCo1_R=SumY×1024/SumR

WBCo1_G=SumY×1024/SumG

WBCo1_B=SumY×1024/SumB

Where SumY=(SumR+2+SumG+SumB)/4.

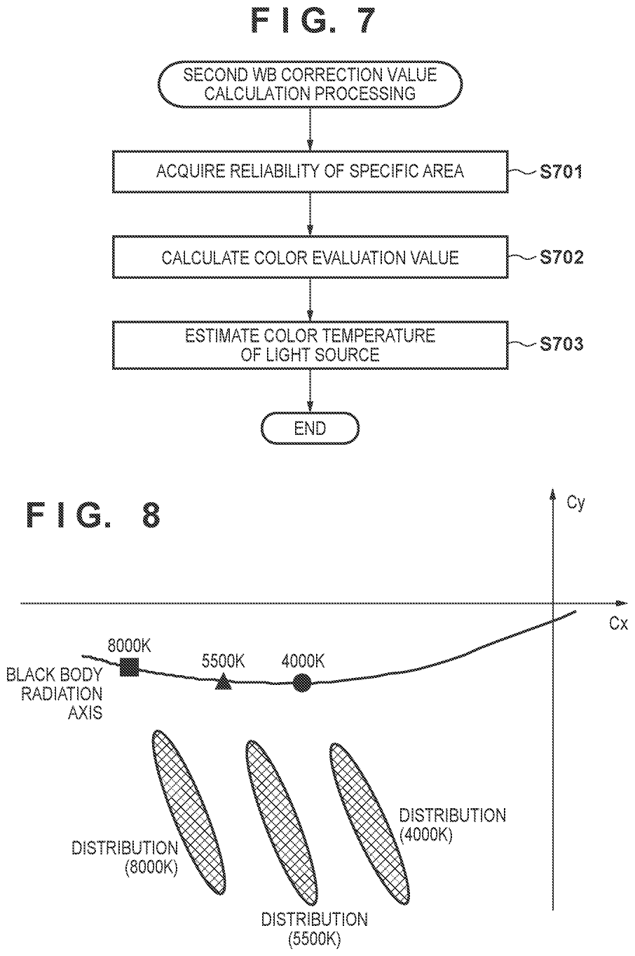

The process returns to step S402 in FIG. 4, and in step S402, the WB control unit 203 calculates a second WB correction value from the evaluation value of the specific area. The calculation of the second WB correction value will be described with reference to the flowchart of FIG. 7.

In step S701, the WB control unit 203 acquires the reliability of the specific area output from the detection unit 202. Here, as described above, the reliability A of the natural greenness of grass, turf, leaves, etc. and the skin-likeness of a person output for each block is acquired. The reason for extracting green and skin is that natural green and human skin exist within a specific color evaluation value range, and an appropriate white balance correction value can be inferred by judging the evaluation value.

In step S702, the WB control unit 203 multiplies the acquired reliability A of each block by the RGB signal value of the corresponding block to newly obtain (R′ [i], G′ [i], and B′ [i]), and then calculates the color evaluation value (Cx[i], Cy[i]) of the specific area for each block in the same manner as in FIG. 5. Furthermore, as shown in the following equation, the reliability of each block and the signal value for each RGB are integrated to calculate the color evaluation value of a specific color in the entire image. A[i]×R[i], A[i]×G[i], and A[i]×B[i] in the following equations correspond to the above-described [i], G′ [i], and B′ [i], respectively.

$${SumR}^{′} = {\sum }_{i = 0}^{m} A [ i ] \times R [ i ]$$

$${SumG}^{′} = {{\sum }_{i = 0}}^{m} A [ i ] \times G [ i ]$$

$${SumB}^{′} = {{\sum }^{m}}_{i = 0} A [ i ] \times B [ i ]$$

Alternatively, in the same manner as the white detection range 601 described above, it may be determined whether or not the color evaluation value is included in the detection range of the green area (refer to FIG. 6B) or the detection range of the skin area (refer to FIG. 6C) set in advance, and integration may be performed.

$${SumR}^{′} = {\sum }_{i = 0}^{m} S w [ i ] \times A [ i ] \times R [ i ]$$

$${SumG}^{′} = {{\sum }^{m}}_{i = 0} S w [ i ] \times A [ i ] \times G [ i ]$$

$${SumB}^{′} = {\sum }_{i = 0}^{m} S w [ i ] \times A [ i ] \times B [ i ]$$

The color evaluation value (Cx′, Cy′) of the specific area is calculated from the integrated value (SumR′, SumG′, SumB′) calculated above. Here, when the integrated value is 0 or the reliability A of the specific area is 0, the first WB correction value already obtained is used.

In step S703, the WB control unit 203 estimates the color temperature of the environmental light source from the color evaluation value (Cx′, Cy′) calculated in step S702. FIG. 8 is a diagram showing the distribution of evaluation value of various grass, turf, and the like. Since the green distribution is different for each light source color temperature, it is possible to estimate the color temperature of the environmental light source from its distribution. That is, the color temperature is estimated based on which green distribution the color evaluation value calculated in step S702 exists in. For example, when the color estimation values (Cx′, Cy′) exist in green distribution around 8000K, the color temperature of the environmental light source is estimated to be 8000K, and 8000K on the black body radiation axis is set as the second white balance correction value (WBCo2).

Although FIG. 8 shows the distribution of the evaluation value of grass, turf, and the like, the distribution of the skin of a person differs depending on the color temperature of the environmental light source, so that the color temperature can be estimated similarly to the green distribution, and the second WB correction value may be determined from the skin area of the person.

Returning to step S403 of FIG. 4, in step S403, the WB control unit 203 calculates the reliability of the second WB correction value from the color evaluation value distribution for each block of the area determined to be the specific area. Here, the reliability is calculated to detect that the output result from the detection unit 202 is incorrect, and to detect the fact that the color temperature of the environmental light source is in a situation that it is difficult to estimate, and the like.

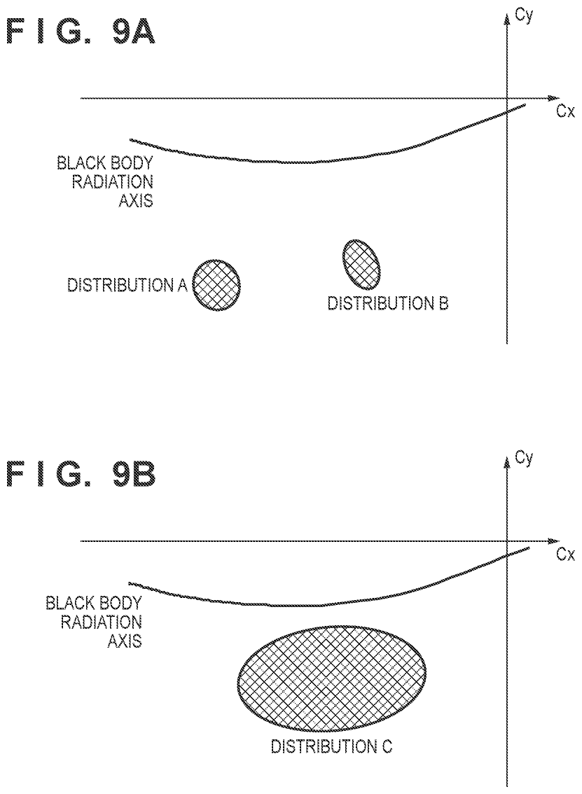

For example, when the distribution of the color evaluation value for each of the blocks in the specific area is divided and distributed as shown in FIG. 9A, there is a possibility that one of the color evaluation values may be erroneously detected. In this case, it is determined that the color temperature of the environmental light source is in a situation in which it is difficult to estimate, and it is determined that the reliability of the second WB correction value obtained by integrating the block is low In addition, when the variation of the color evaluation value for each block is large as shown in FIG. 9B, it is determined that the color temperature estimation accuracy of the environmental light source is low, and it is determined that the reliability of the second WB correction value is low

As a method of calculating the reliability, there is a method of calculating the variance value of the color evaluation value of the specific area for each block extracted by the detection unit 202. The variance value is calculated using the equation shown below, and when the variance value is equal to or larger than a certain threshold value, it is determined that the reliability of the second WB correction value is low.

$$VarCx = \frac{1}{n} {\sum }_{j = 1}^{n} {( Cx [ j ] - AveCx )}^{2}$$

$$VarCy = \frac{1}{n} {\sum }_{j = 1}^{n} {( Cy [ j ] - AveCy )}^{2}$$

AveCx: Average Color Evaluation Value of Specific Area (Cx)
AveCy: Average Color Evaluation Value of Specified Area (Cy)

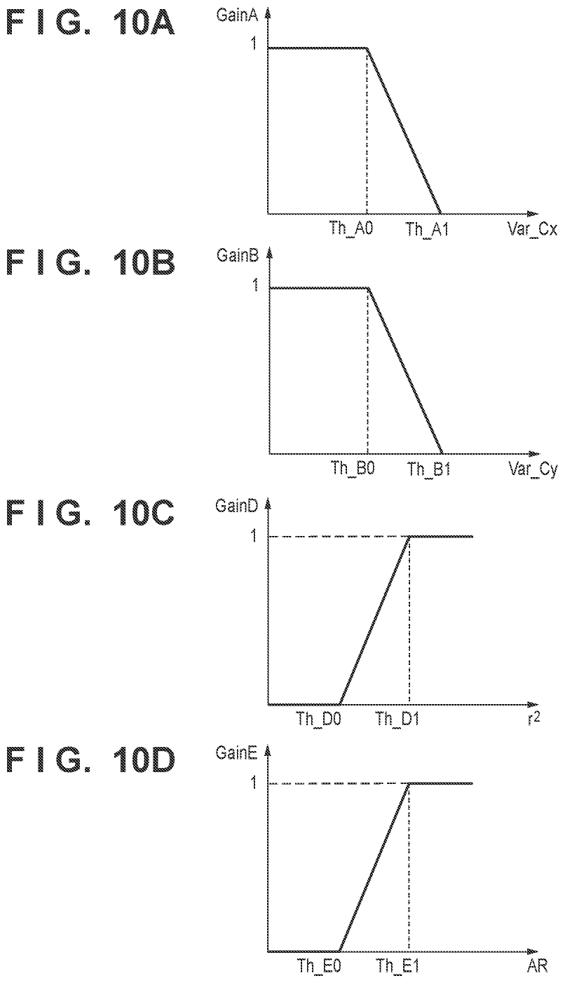

As shown in FIGS. 10A and 10B, GainA and GainB are obtained from the variance value of the color evaluation value, and the reliability of the second WB correction value by the variance value is calculated.

GainC=GainA×GainB

In the above description, when the variance is large, it is determined that the reliability of the second WB correction value is low, but when the color evaluation values of various natural greens such as grass and turf are plotted as shown in FIG. 8, the distribution shape has a certain spread under the same color temperature environment. From this characteristic, the distribution correlation under the same color temperature environment is calculated and if the correlation is high, it can be determined that the reliability of the second WB correction value is high even when the variance value is large for the color evaluation value of the green area.

As a method of calculating the correlation, the correlation (linear correlation value) of the linear approximation formula is calculated from the color evaluation value of the green area, and the reliability of the second WB correction value is calculated from the correlation. The correlation calculation formula is as follows.

$${r}^{2} = \frac{{( {\sum }_{j = 1}^{i = n} ( Cx [ j ] - AveCx ) ( Cy [ j ] - AveCy ) )}^{2}}{{\sum }_{j = 1}^{i = n} {( Cx [ j ] - AveCx )}^{2} {\sum }_{j = 1}^{i = n} {( Cy [ j ] - AveCy )}^{2}}$$

This correlation coefficient takes a value of 0 to 1, and when it is close to 1, it is determined that there is a correlation, that is, the shape of the green distribution.

Gain D is calculated as shown in FIG. 10C by using r ² calculated above as the correlation coefficient. When calculating the second WB correction value in the green area, the reliability shall be determined by the maximum value of Gain C and Gain D.When the second WB correction value is calculated in the skin area, the reliability may be determined only by Gain C.

α=max{GainC, GainD}

Further, when the area ratio of the specific area is low, there is a possibility that the calculation accuracy of the second WB correction value is low, and therefore, the reliability of the second WB correction value is calculated also based on the area ratio. As shown in FIG. 10D, GainE is calculated in accordance with the area ratio AR (the area of the specific arealthe area including the area other than the specific area). Therefore, the reliability β of the second WB correction value is as follows.

β=α×GainE

The reliability β calculated above is defined as a mixing ratio for weighted addition of the first WB correction value and the second WB correction value.

In step S404, the first WB correction value and the second WB correction value are weighted and added to each other by the mixing ratio calculated above, thereby the final white balance correction value (WBCo) is calculated.

WBCo=(1−β)×WBCo1β×WBCo2

In the above embodiment, the image processing apparatus of the present invention is exemplified by a digital camera, but the present invention is not limited thereto. For example, the present invention can be applied to a digital video camera or an information processing apparatus including a digital camera, for example, a personal computer, a mobile terminal, and the like.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-033749, filed Feb. 28, 2020 which is hereby incorporated by reference herein in its entirety.

What is claimed is:

1. An image processing apparatus comprising:
at least one processor or circuit configured to function as:
an acquisition unit configured to acquire image data;
a determination unit configured to determine a specific area from the acquired image data;
a first calculation unit configured to calculate a first white balance correction value in accordance with white pixels of an area including an area other than the specific area;
a second calculation unit configured to calculate a second white balance correction value based on a color evaluation value of the specific area; and
a third calculation unit configured to calculate a third white balance correction value by performing weighted addition of the first white balance correction value and the second white balance correction value based on a distribution of the color evaluation value of the specific area.

2. The image processing apparatus according to claim 1, wherein the determination unit determines the specific area using machine learning.

3. The image processing apparatus according to claim 1, wherein the specific area is a green area existing in nature.

4. The image processing apparatus according to claim 1, wherein the specific area is a skin color area of a person.

5. The image processing apparatus according to claim 1, wherein the determination unit determines a reliability of the specific area by machine learning.

6. The image processing apparatus according to claim 1, wherein the second calculation unit integrates the color evaluation values according to a reliability of the specific area.

7. The image processing apparatus according to claim 6, wherein the second calculation unit determines whether or not the color evaluation value of the specific area falls within a predetermined range, and integrates the color evaluation values based on the result of the determination.

8. The image processing apparatus according to claim 1, wherein the third calculation unit calculates a mixing ratio of the first white balance correction value and the second white balance correction value in the weighted addition based on the distribution of the color evaluation value of the specific area.

9. The image processing apparatus according to claim 8, wherein the third calculation unit increases the mixing ratio of the second white balance correction value in a case that the specific area exists in the image data.

10. The image processing apparatus according to claim 8, wherein the third calculation unit sets the mixing ratio of the second white balance correction value to 0 when the specific area does not exist in the image data.

11. The image processing apparatus according to claim 8, wherein the third calculation unit calculates a variance value of the color evaluation value of the specific area, and calculates a mixing ratio of the first white balance correction value and the second white balance correction value based on the variance calculation result.

12. The image processing apparatus according to claim 8, wherein the third calculation unit calculates a linear correlation value of the color evaluation value of the specific area, and calculates a mixing ratio of the first white balance correction value and the second white balance correction value based on the linear correlation calculation result.

13. The image processing apparatus according to claim 8, wherein the third calculation unit calculates a ratio of an area of the specific area to an area including an area other than the specific area, and calculates a mixing ratio of the first white balance correction value and the second white balance correction value based on the ratio calculation result.

14. The image processing apparatus according to claim 13, wherein the third calculation unit increases the mixing ratio of the second white balance correction value as the ratio of the areas of the specific area increases.

15. The image processing apparatus according to claim 13, wherein the third calculation unit increases the mixing ratio of the first white balance correction values as the ratio of the areas of the specific areas decreases.

16. An image processing method comprising:
acquiring an image data;
determining a specific area from the acquired image data,
performing a first calculation for calculating a first white balance correction value in accordance with white pixels of an area including an area other than the specific area,
performing a second calculation for calculating a second white balance correction value based on a color evaluation value of the specific area,
performing a third calculation for calculating a third white balance correction value by performing weighted addition of the first white balance correction value and the second white balance correction value based on a distribution of the color evaluation value of the specific area.

17. A non-transitory computer readable storage medium storing a program for causing a computer to perform an image processing method, the method comprising:
acquiring an image data;
determining a specific area from the acquired image data,
performing a first calculation for calculating a first white balance correction value in accordance with white pixels of an area including an area other than the specific area,
performing a second calculation for calculating a second white balance correction value based on a color evaluation value of the specific area,
performing a third calculation for calculating a third white balance correction value by performing weighted addition of the first white balance correction value and the second white balance correction value based on a distribution of the color evaluation value of the specific area.
